(19) United States
(12) Patent Application Publication
(10) Pub. No.: US 2010/0329354 A1
(43) Pub. Date: Dec. 30, 2010

(54) SYSTEMS AND METHODS FOR ACHIEVING OPTIMAL DIGITAL VIDEO CHANNEL CHANGE PERFORMANCE

(75) Inventors: Marcus Kellerman, San Diego, CA (US); Jeffrey P. Fisher, Dublin, CA (US); Alex Pelts, Morgan Hill, CA (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/493,464

(22) Filed: Jun. 29, 2009

(51) Int. Cl. H04N 11/02

(52) U.S. Cl. 375/240.25

(57) ABSTRACT

A method providing digital video channel change performance according to the invention is provided. The method may include decoding stored data packets associated with a first program. The method may also include displaying the decoded data packets associated with the first program. The method may further include demultiplexing a plurality of data packets associated with a second program and storing the plurality of data packets associated with the second program. The stored data packets associated with the second program may include a first random access point. The method may also include maintaining data associated with the first random access point until data associated with a second random access point is received.

### FIELD OF TECHNOLOGY

This disclosure relates to digital video channel change performance. More particularly this disclosure relates to systems and methods for optimizing digital video channel change performance.

Any publication referred to in this patent application is preferably incorporated by reference herein in its entirety.

### BACKGROUND OF THE INVENTION

Broadcast digital cable, terrestrial and satellite networks distribute audio, video and data via multiplexed bitstreams. For the purposes of this application, such multiplexed bitstreams may be referred to herein as a “multiplex” and can be understood to refer to digital data streams that are combined into one streaming signal over a shared medium. The mutilplexed signal is typically transmitted over a physical communication medium. Such multiplexed bitstreams may follow a protocol specified by ISO/IEC13818-1, which is hereby incorporated by reference herein in its entirety.

A typical broadcast network may distribute many multiplexed bitstreams. One level of complexity of this distribution is attributable to the fact that each of the multiplexed bitstreams may carry a number of digital video/audio programs. Additionally, acquiring the digital signals themselves is a complex process. These complexities, among other factors, slow down the process of changing channels from one program to another program. In fact, changing channels between programs on a typical digital network may take much longer than changing channels in legacy analog broadcast environments.

There are several steps required to perform a broadcast digital video channel change. The event sequence shown in FIG. 1 subdivides digital video channel change into a series of operations. Cable, satellite and terrestrial broadcasts subdivide the RF spectrum into RF channels. The first step in the event sequence shown in FIG. 1 is to tune to a specific RF channel containing a multiplexed stream which contains the desired program, as shown in 102.

Once RF tuning is complete, a digital signal is then acquired and demodulated, as shown at demodulator lock 104. The type of demodulation typically depends on the type of broadcast network. Nevertheless, many factors can influence the amount of time required to acquire and successfully demodulate the signal.

A conventional demodulated bitstream typically includes a multiplexed bitstream as described in ISO/IEC13818-1. For the purposes of discussing digital video channel change in this application, the multiplexed bitstream can be viewed as an alternating series of packets. In FIG. 2, each of the packets 202-224 is labeled according to the program with which it is associated.

It is known for a single multiplex bitstream to carry 10 or more different programs, each program being analogous to an audio/video channel. The bitstream also may carry data known as Program Specific Information (PSI), which may be acquired as shown at 106 of FIG. 1. PSI information is used to help identify the programs in the multiplex (see, e.g., 2.4.4 Program Specific Information, ISO/IEC13818-1). Using the PSI information, the bitstream can be separated into distinct programs (channels).

In some broadcast system, individual programs can be encrypted or scrambled and often there is periodic PSI information in the bitstream necessary to decrypt or descramble the stream. This data is often referred to as Entitlement Control Messages (ECM). Acquisition of ECM is shown at 108.

Although requirements may vary with different digital video formats, digital video data carried in a bitstream is typically formatted in a predetermined sequence. A conventional sequence of the digital video data requires waiting for certain specific data prior to decoding and displaying the video data, as per ISO/IEC13818-2 section 6.1.1.6.

Other bitstream requirements that precede decoding and displaying of video may also exist in conventional systems. Such requirements may relate to the number of pictures, buffering and other dependent data such as audio data that must be received before a decoder can decode and display pictures having a sound track associated therewith. The amount of time consumed by video acquisition, as shown in 110, typically depends, at least in part, on when the video acquisition process begins as well as other encoding factors.

Specifically, the amount of time it takes to complete video acquisition depends, at least in part, on when sufficient data for the program is received by the decoder.

### SUMMARY OF THE INVENTION

A system and/or method for implementing a digital video channel change, substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of a conventional channel change event sequence;

FIG. 2 is a schematic diagram of a conventional multiplexed bitstream;

FIG. 3 is a schematic diagram of a conventional video acquisition of an exemplary program from a multiplexed bitstream;

FIG. 4 is a schematic diagram of a conventional method for buffering program data;

FIG. 5 is a schematic diagram of a technique according to the invention for improved channel change in a digital broadcast system;

FIG. 6 is a schematic diagram of a continuation of the technique shown in FIG. 5;

FIG. 7 is a schematic diagram of implementation of a technique for digital channel change on a platform with multiple tuners and demodulators;

FIGS. 8-10 are schematic diagrams of additional processes according to the invention;

FIG. 10 is a schematic diagram of the operation of a primer according to the invention;

FIG. 11 is a schematic diagram of the discontinuation of the operation of a primer according to the invention;

FIG. 12 is a schematic diagram of a linear channel list;

FIG. 13 is another schematic diagram of a linear channel list; and

FIG. 14 shows a schematic diagram of an illustrative single or multi-chip module of this invention in a data processing system.

### DETAILED DESCRIPTION OF THE INVENTION

This patent application describes systems and methods for achieving improved and/or optimal digital video channel change performance in broadcast terrestrial cable or satellite networks. More specifically, the method described herein improves upon and is derived from conventional implementations of digital video channel change.

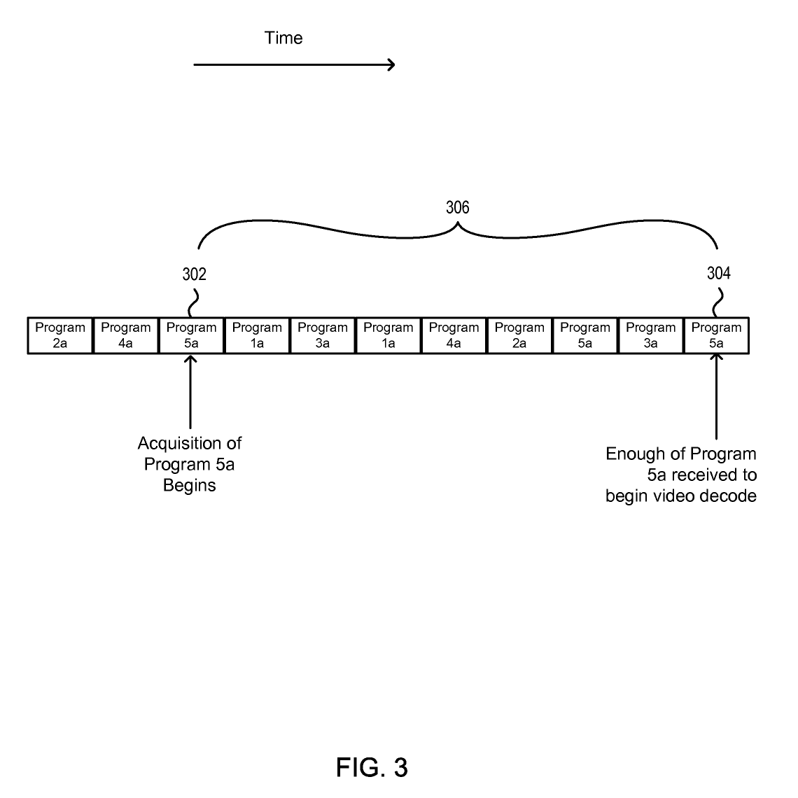

FIG. 3 shows a schematic diagram of conventional video acquisition of exemplary program 5a from a multiplexed bitstream.

Point-in-time 302 shows the point in time when acquisition of exemplary program 5a begins. Point-in-time 304 shows when sufficient data of program 5a has been accumulated in order to allow the video decoding of program 5a to initiate and continue uninterrupted. The amount of sufficient data to allow decoding of program 5a may include an amount of data that ensures receipt and maintenance of least one random access point. Random access points are typically encoded in the video sequence to allow starting of video decoding of a predetermined program from an arbitrary point. A decoder may possess the ability to find a random access point in an incoming stream of data. The total amount of time to allow decoding of program 5a is shown as 306.

The multiplexed video for program 5a is typically received with intermittent and indeterminate delays. Such delays may occur between sections of the desired program. Accordingly, it may be necessary to accumulate, and preferably maintain, sufficient data to insure that video decode and display can continue uninterrupted.

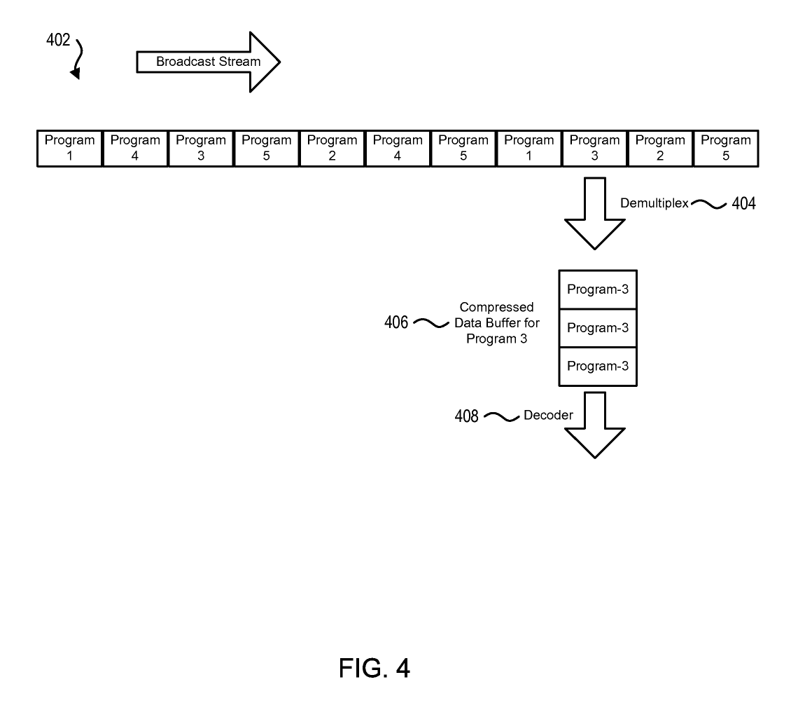

FIG. 4 shows a schematic diagram of buffering program data. The buffered data is often stored in a video first-in-first-out (“FIFO”) buffer, referred to in the alternative herein as a compressed data buffer (“CDB”). Before the decoder can decode and display video frames, enough data should be accumulated in the compressed data buffer. In the absence of sufficient amounts of accumulated data, the buffer could become empty before more data is received.

The broadcast stream is depicted schematically at 402. The broadcast stream is demultiplexed at 404. Data for the display of Program 3 is stored in a compressed data buffer at 406. When sufficient data has been accumulated at 406, decoding for display may begin at 408.

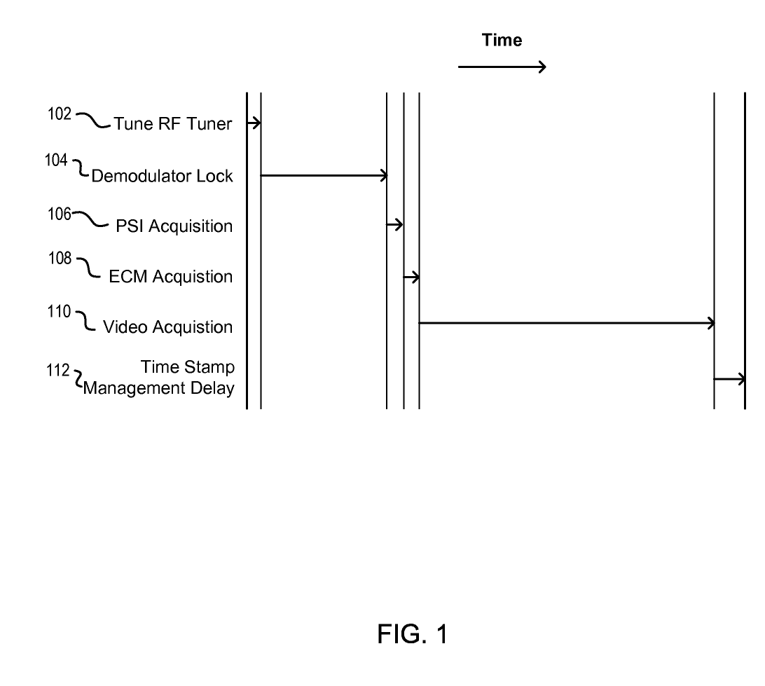

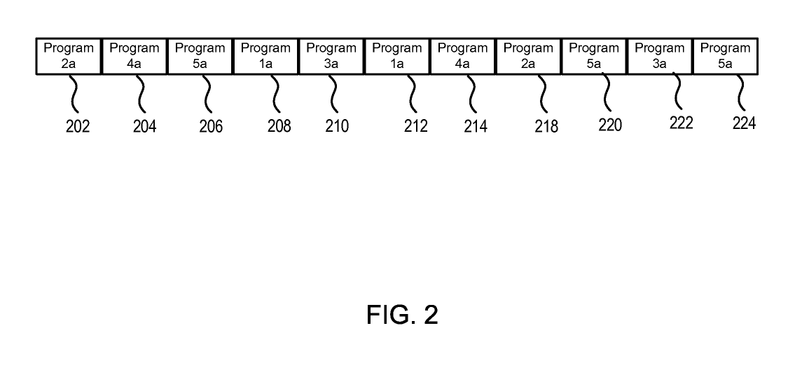

Also, video data may contain information (timestamps) to insure the display is ordered and presented for display at the proper point in time. Such display must be synchronized with audio data also multiplexed in the bitstream. This delay is referred to as the timestamp management (TSM) delay, and is shown at 112 in FIG. 1. Section D of ISO/IEC 13818-1 provides a general discussion of an exemplary timing model employed for encoding, transmission and decoding for digital video broadcast.

In order to analyze an exemplary video acquisition and TSM delay in a broadcast cable network with an MPEG-2 bitstream, five distinct events may be collected. These events include:

RF Tune Time

Demodulator Acquisition

PSI Acquisition

Sequence Header—First sequence header (ISO/IEC13818-2 section 6.1.1.6) observed; also approximates the “video acquisition” time.

First PTS—First video frame presentation time; also approximates the TSM delay.

An example of the sequence header and first PTS times seen in typical broadcast cable bitstreams is shown in Table 1. Table 1 breaks down the components of an exemplary channel change duration. The units used are milliseconds:

| RF | | | Seq. | First | |
|---|---|---|---|---|---|
| Tune | Demod. | PSI | Header | PTS | |
| 30 | 362 | 51 | 195 | 92 | |
| 30 | 342 | 56 | 788 | 121 | |
| 30 | 344 | 16 | 960 | 134 | |
| 30 | 345 | 22 | 552 | 125 | |
| 30 | 392 | 23 | 663 | 115 | |
| 30 | 383 | 34 | 206 | 127 | |
| 30 | 342 | 39 | 982 | 123 | |
| 30 | 366 | 64 | 823 | 155 | |
| 30 | 350 | 28 | 679 | 115 | |
| 30 | 373 | 32 | 1439 | 107 | |
| 30 | 325 | 54 | 206 | 105 | |
| 30 | 334 | 18 | 1207 | 128 | |
| 30 | 362 | 12 | 1081 | 120 | |
| 30 | 359 | 66 | 948 | 136 | |
| 30 | 380 | 67 | 406 | 116 | |
| 30 | 357 | 39 | 742 | 121 | Avg |

It should be noted according to methods of the invention, when changing channels between programs in the same multiplexed bitstream it is not necessary to tune (as represented by 102 in FIG. 1) and obtain demodulation lock (as represented by 104 in FIG. 1), thereby shortening the channel change sequence. Furthermore, in conventional broadcast systems, the PSI data is obtained each time a multiplex is acquired. However, if the information does not change often, it is possible that the step of obtaining PSI data may, under certain conditions, and using systems and/or methods according to the invention, be omitted.

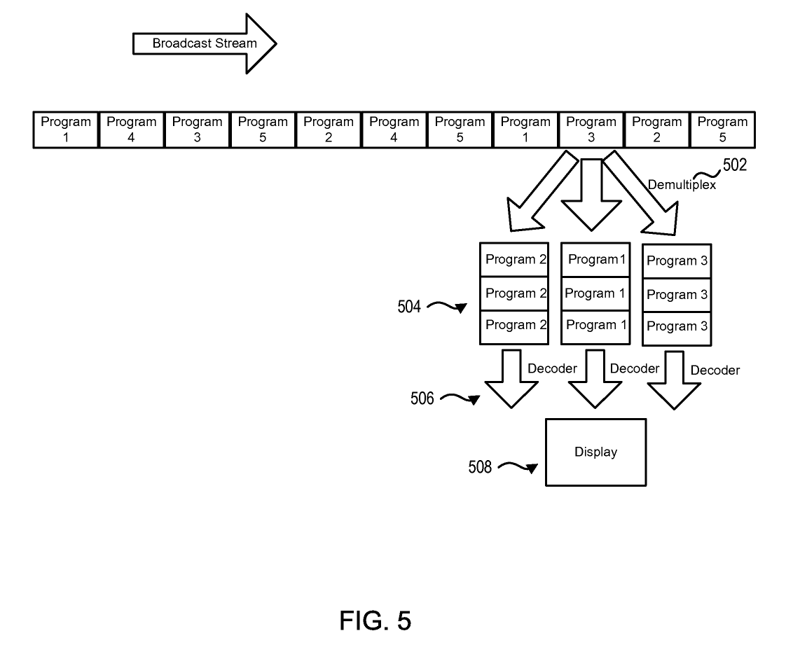

FIG. 5 shows a schematic diagram of a technique according to the invention for implementing relatively faster channel change in a digital broadcast system. In the technique shown in FIG. 5, channel change performance may be improved by demultiplexing, buffering and decoding multiple programs simultaneously, as shown at 502, 504 and 506, respectively. One of the programs is decoded and shown on the video display, as shown at 508; several others are decoded but not displayed.

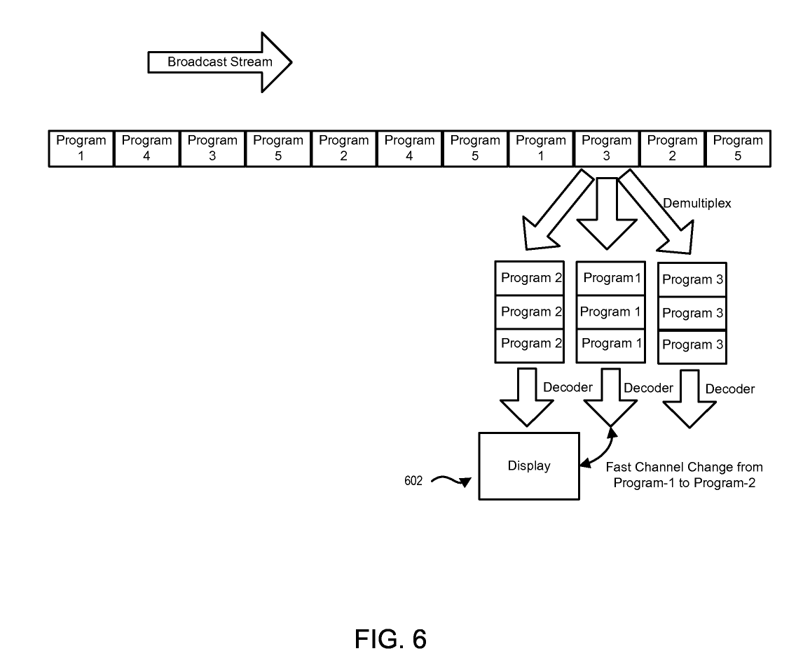

FIG. 6 shows a schematic diagram of implementation of a technique according to the invention. A relatively fast channel change may be implemented because the display can be driven from one decoder to another decoder that is already decoding the new program. Specifically, step 602 shows changing the decoder that drives the display. Preferably, this channel change according to the invention can occur within one or several video frame times.

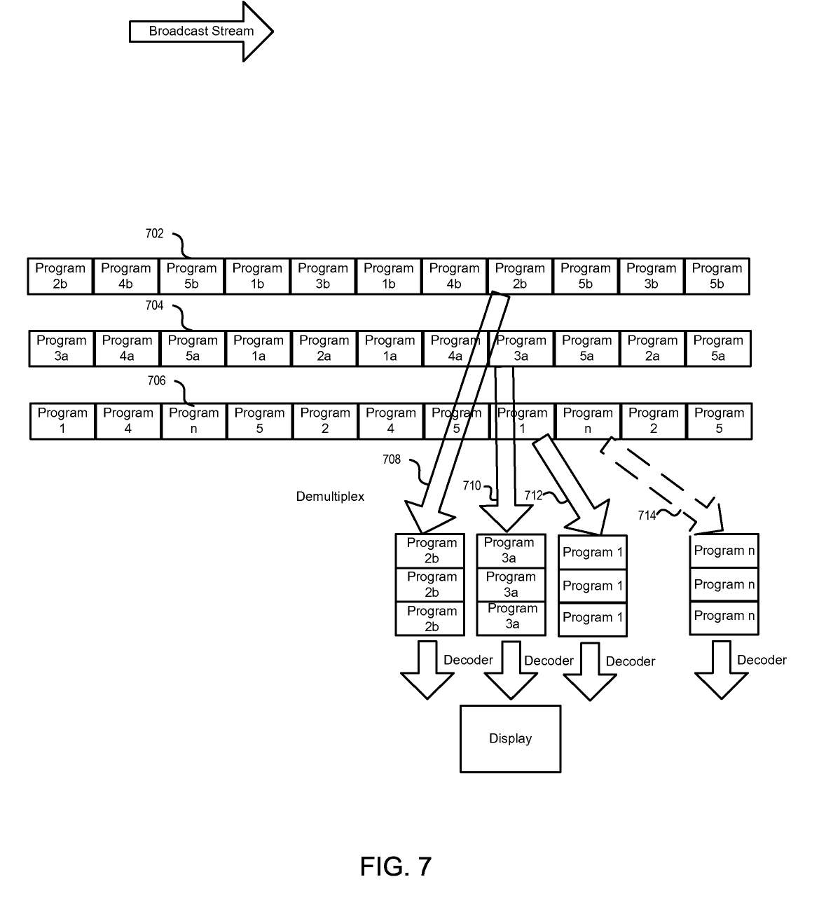

FIG. 7 shows a schematic diagram of implementation of a technique for digital channel switching on a platform with multiple tuners and demodulators. This method can be employed to quickly change between programs in different multiplexed bitstreams.

Schematic representations of multiple bitstreams are shown at 702, 704, and 706, respectively. One of the programs in each bitstream is shown as being demultiplexed at each of 708, 710 and 712, respectively. An additional program, n, is shown as being demultiplexed at 714. Program n indicates that techniques according to the invention are adaptable to any suitable implementation, preferably independent of the total bitstream number and/or the total program number.

As long as the channel change occurs between channels in the same multiplex (or another multiplex already acquired on multiple tuner/demodulator systems) channel change can, according to the invention, occur substantially nearly instantaneously. The decreased time duration of the channel change may be attributable, at least in part, to the fact that PSI acquisition (see 106 in FIG. 1) and ECM processing (see 108 in FIG. 1) has already been completed for all programs being decoded prior to the channel change.

Yet another aspect of the invention relates to optimized digital video channel change. While simultaneous decoding of programs improves speed, nevertheless, performing simultaneous decodes consumes a great deal of processing power and memory bandwidth, particularly with high definition video streams.

This additional load can be almost completely eliminated by implementing processes, according to the invention, that replace additional video decoders (see e.g., 506) needed to implement the digital video channel change described above in FIGS. 5-7.

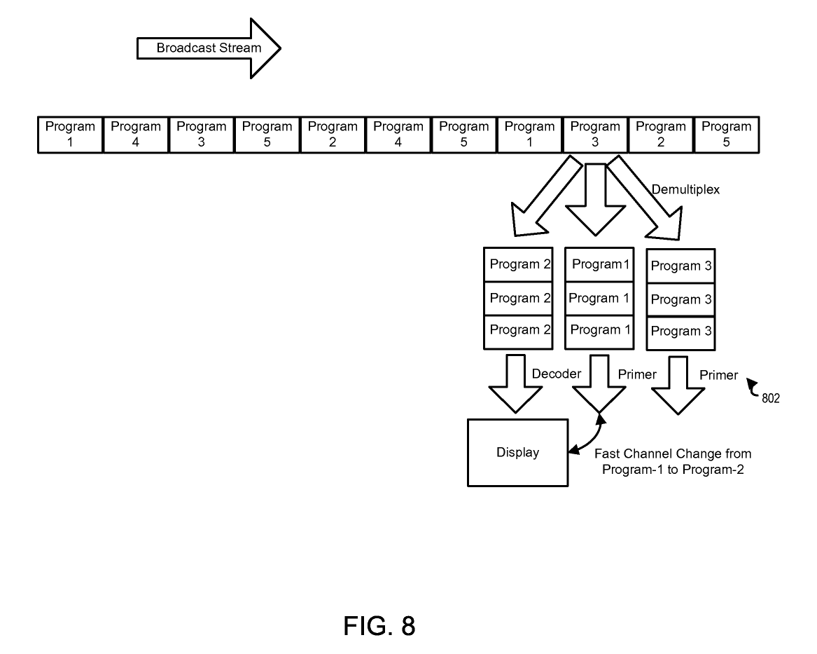

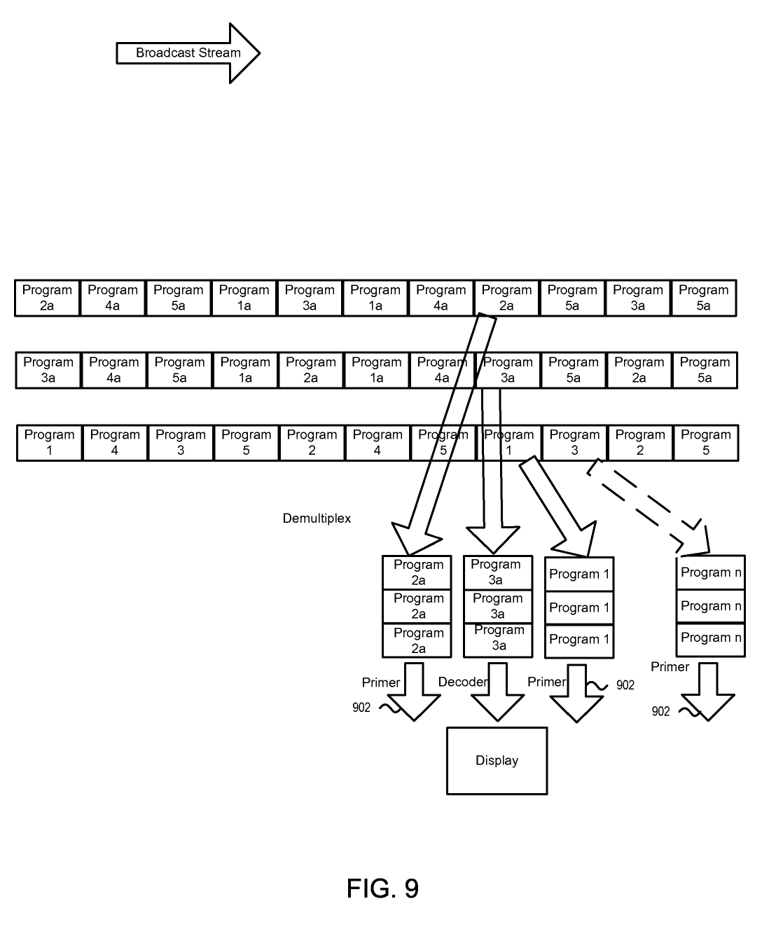

FIGS. 8-9 show schematic diagrams of processes that replace the additional video decoders. Processes for reducing consumption of processing power and memory bandwidth use primers 802, 902. In some embodiments of the invention, a primer is responsible for maintaining just enough video data in the compressed data buffer so that a video decoder can immediately start video decode. The operating characteristics of such primers, as well as other, less sophisticated primers, are described in more detail below.

In some embodiments, a primer according to the invention parses the bitstream and searches for pictures where a decode can begin—e.g., random access points. Once the primer identifies a random access point, the primer can maintain the random access point in storage, dispose of the previous video data, and continue to parse through incoming data for the next random access point. Whereas a decoder has the ability to identify a random access point, the decoder typically must always parse through incoming video data to find the random access point. The decoder does not identify the random access point and discard the extraneous data. The primer, on the other hand, may identify a random access point and then maintain the random access point in storage—e.g., a buffer, until the primer identifies a new random access point. In other words, to start decoding, the decoder must find a random access point by parsing through the incoming stream. The primer, on the other hand, looks for the random access point in the information already received. When a channel change event happens, a primer may substantially immediately provide a random access point for decoding instead of first searching for a random access point and then providing the random access point.

The primer may also operate as a consumer of video data. Specifically, the primer receives video data and may discard the non-random-access-point video data while storing information relating to the most recently received random access point data. As above, a primer may continually search through video data for a random access point and keep one ready for initiation of a decoding process. Elimination of the need to locate a random access point is what makes the channel change quicker.

In a system supporting optimized digital video channel change according to the invention, the decoder can decode and display the active program. Further, any suitable number of primers may be utilized to process other streams in the same multiplex or streams present in other multiplexes if multiple tuners and demodulators are employed.

Because primers maintain enough video data in a compressed data buffer such that the decoder can immediately decode and display using the video data buffered by the primer, a very fast channel change can occur by switching which compressed buffer the decoder processes.

As described above, the primer is responsible for maintaining preferably just enough data in a compressed data buffer to decode and display video. The amount of data and requirements for the types of data depend on the encoding standard of the video—e.g., ISO/IEC 13818-2 MPEG-2, ISO/IEC MPEG-4, SMPTE 421M VC-1, etc., each of which is incorporated by reference herein in its entirety.

The hardware-based CDB associated with a primer places the demultiplexed video data received in a buffer. If the video stream represents a channel that is not being viewed, the primer consumes data at the end of the buffer. In one preferred embodiment of the invention, the primer maintains buffer fullness at an optimal level so that initiation of a decoding process does not require pre-buffering of video data.

The more sophisticated primer according to the invention described above may substantially continuously maintain a random access point in the buffer. A less sophisticated primer according to the invention may simply consume data from the buffer in order to stop the buffer from overflowing. The less sophisticated primer may consume data (in the place of a decoder and display module) without identifying whether a random access point is currently resident in the buffer associated with the primer.

Thus, in some embodiments of the invention, it is not necessary for the primer to actually process any of the data and, thereby, to obtain an indication of the presence of a random access point in the buffer. Rather, the primer can maintain data necessary to begin video decode, assuming the buffer associated with the primer is sufficiently large to substantially always include a random access point for each program, and also evacuate extraneous or old data.

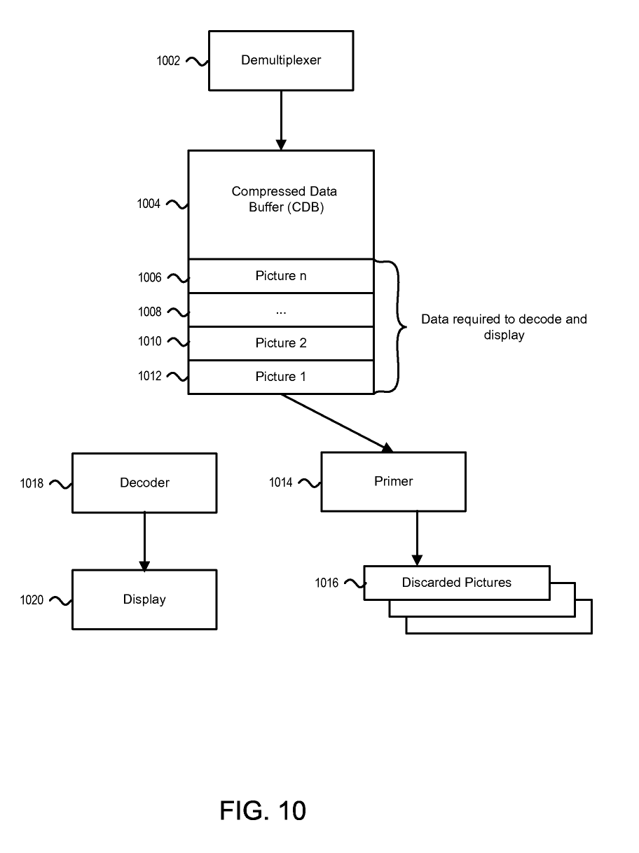

FIG. 10 shows a schematic diagram of the operation of a primer 1014 according to the invention. Primer 1014 can preferably maintain the information stored in buffer 1004 at a suitable amount. Buffer 1004 typically receives the broadcast video data stream from the multiplexer 1002.

Alternatively, primer 1014 can also utilize random access points (sometimes referred to as “start codes”) in the broadcast video data stream 1006-1012 to maintain, preferably, the least possible amount of data necessary for allowing optimal switching to the stream following a channel change. Further, the primer may substantially continuously, or periodically, discard data (pictures) 1016 to maintain only the latest point-in-time video required by the decoder.

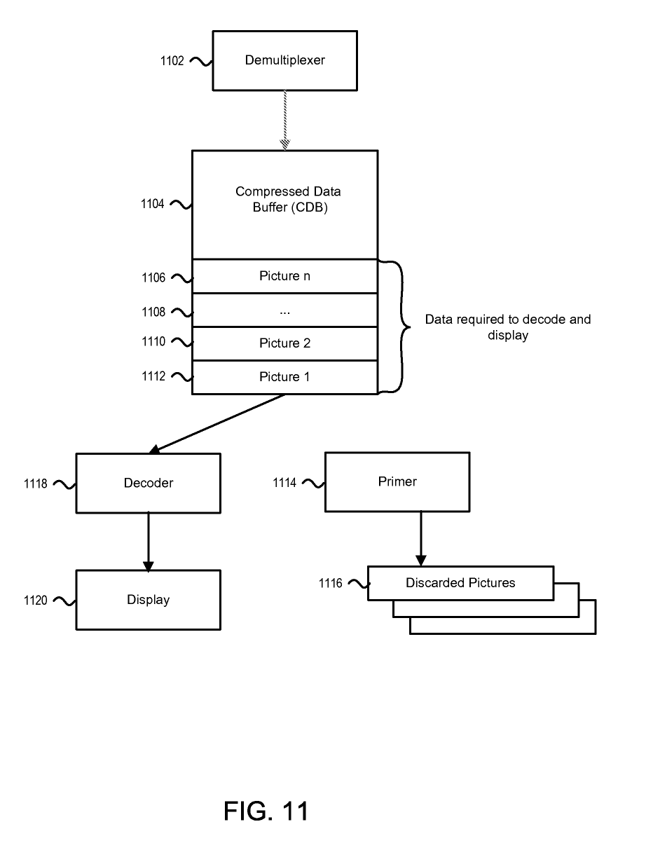

FIG. 11 shows a schematic diagram of the discontinuation of the process shown in FIG. 10 when a channel change occurs. The elements shown in FIG. 11 are similar to the elements shown in FIG. 10. When a channel change occurs, the output of the CDB 1104 maintained by primer 1114 is switched to be consumed by decoder 1118. Because the necessary data is maintained in CDB 1104, decoder 1118 can decode (and display 1120) the frames relatively very quickly. Such methods according to the invention may give a viewer the perception of a nearly instant channel change from one program to the next.

A suitable video engine, such as the RealTime Audio Video Engine (RAVE) in the BCM7002, BCM7003, BCM7004 manufactured by Broadcom Corporation of Irvine, Calif. is suitable to implement software that is configured to perform the tasks of a primer according to the invention. The suitable video engine preferably can scan incoming multiplexed streams and identify the existence of random access points and/or other required video sequences (see BCM7002A0 Transport Architecture Document, which is hereby incorporated by reference herein in its entirety).

Thus, it has been shown that by employing channel management techniques according to the invention to predict programs (channels) to be processed by primers, time consumed by channel change sequence of events can be reduced to approximately the TSM delay (See FIG. 1, 112). By utilizing primers according to the invention, instead of multiple decoders, systems and methods according to the invention can implement a nearly instantaneous channel change without requiring the additional processing and memory bandwidth overhead attributed to decoding multiple programs.

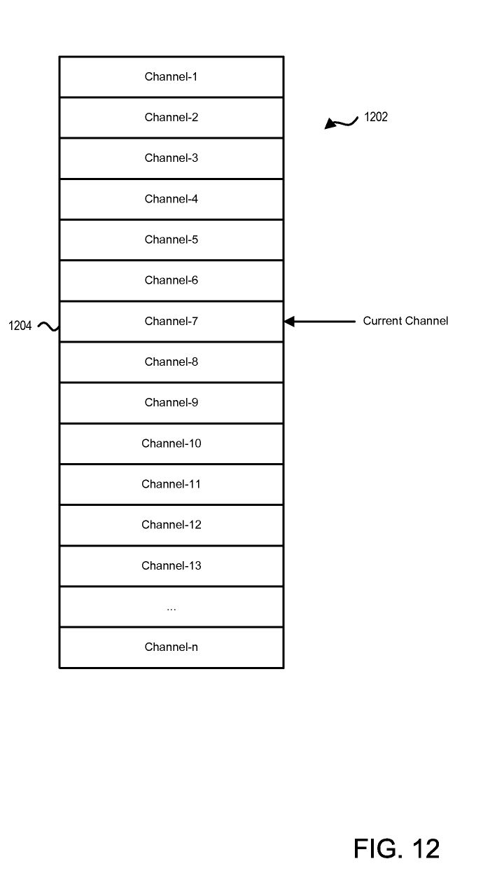

FIG. 12 shows a schematic diagram of a conventional linear channel list 1202. In any system, there is a limit to the number of programs that can be received and processed. In order to perform optimized or fast channel change according to the invention, the system preferably should identify which programs to process in order to achieve the desired channel change performance.

On broadcast terrestrial, cable and satellite networks, channels are customarily organized in a linear format. The paradigm most familiar for changing channels is to simply move a current channel selector up and down in linear list 1202. Such a selector may obtain a selection of a current channel 1204.

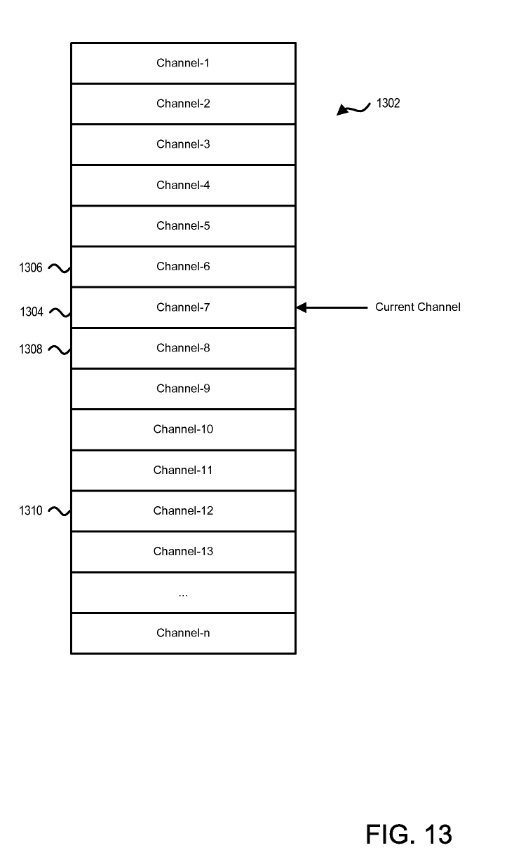

One exemplary algorithm may determine which channels should be pre-processed. A list associated with such an algorithm is shown in FIG. 13. Using current channel 1304 as a point of reference in list 1302, the channels that should be processed can be defined according to the algorithm as the channels next in the list and previous in the list,—i.e., channels 1306 and 1308.

It is also common to jump between two channels, not necessarily in consecutive order. This is commonly referred to as skipping to the “last” channel 1310. If resources are available, the last channel should also be processed so that it is possible to change quickly to/from the last channel.

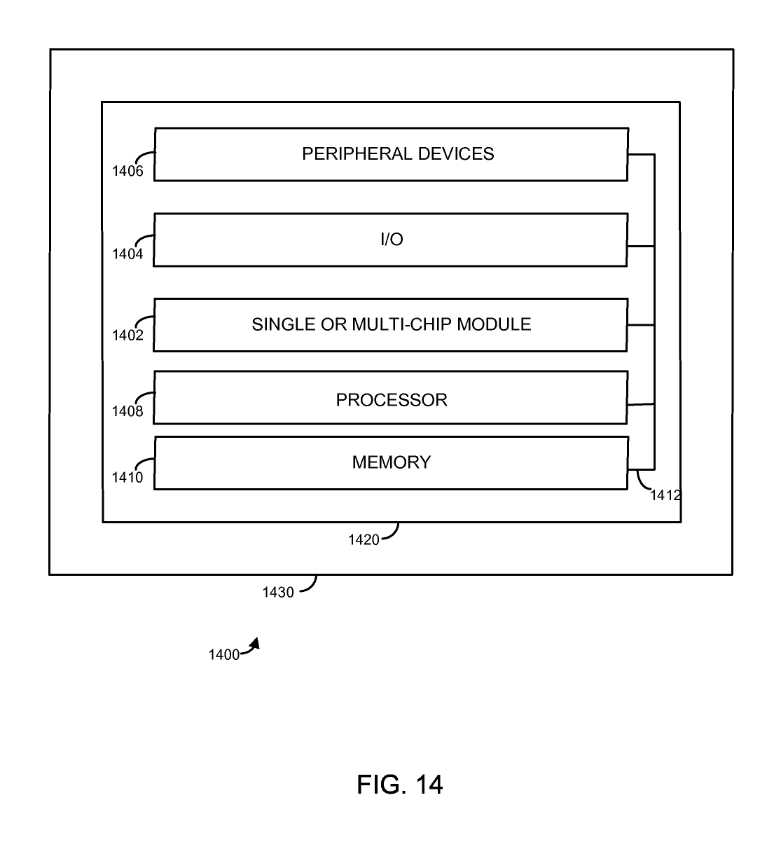

FIG. 14 shows a single or multi-chip module 1402 according to the invention, which can be one or more integrated circuits, in an illustrative data processing system 1400 according to the invention. Data processing system 1400 may include one or more of the following components: I/O circuitry 1404, peripheral devices 1406, a processor 1408 and memory 1410. These components are coupled together by a system bus or other interconnections 1412 and are populated on a circuit board 1420 which is contained in an end-user system 1430. System 1400 may be configured for use in a computer according to the invention. It should be noted that system 1400 is only exemplary, and that the true scope and spirit of the invention should be indicated by the following claims.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional.

Thus, systems and methods for improving digital video channel change performance have been described. Persons skilled in the art will appreciate that the present invention can be practiced by other than the described embodiments, which are presented for purposes of illustration rather than of limitation, and the present invention is limited only by the claims which follow.

What is claimed is:

1. A method for changing programs between multiplexed programs in a digital data stream, the method comprising:
receiving a digital bitstream comprising multiplexed programs;
decoding and displaying a plurality of data packets associated with a first program;
demultiplexing a plurality of data packets associated with a second program;
storing the plurality of data packets associated with a second program in a compressed data buffer; and
maintaining a sufficient number of data packets associated with the second program to enable decoding and displaying of the second program independent of a delay associated with video acquisition of the second program.

2. The method of claim 1 further comprising storing the plurality of data packets associated with the first program in a compressed data buffer.

3. The method of claim 1 the maintaining further comprising maintaining a random access point associated with the second program in a compressed data buffer.

4. The method of claim 1 further comprising:
demultiplexing a plurality of data packets associated with a third program;
storing the plurality of data packets associated with a third program in a compressed data buffer; and
maintaining a sufficient number of data packets associated with the third program to enable decoding and displaying of the third program independent of a delay associated with video acquisition of the third program.

5. A method for changing programs between multiplexed programs in a digital broadcast, the method comprising:
receiving a digital bitstream comprising a plurality of multiplexed programs;
demultiplexing a plurality of data packets associated with a first program of the plurality of multiplexed programs;
storing the plurality of data packets associated with the first program in a compressed data buffer;
decoding the stored data packets associated with the first program;
displaying the decoded data packets associated with the first program;
demultiplexing a plurality of data packets associated with a second program;
storing the plurality of data packets associated with the second program in a compressed data buffer, wherein the stored data packets associated with the second program include a random access point; and
discarding data packets associated with the second program that are received at a point earlier-in-time than the random access point.

6. The method of claim 5 further comprising discarding a data packet associated with the random access point upon receipt of a data packet associated with a second random access point, said second random access point associated with the second program.

7. The method of claim 5 further comprising demultiplexing a plurality of data packets associated with the first program.

8. The method of claim 5 further comprising storing the plurality of data packets associated with the first program in a compressed data buffer.

9. The method of claim 5 the maintaining further comprising substantially continuously maintaining a random access point associated with the second program in the compressed data buffer.

10. The method of claim 5 further comprising:
demultiplexing a plurality of data packets associated with a third program;
storing the plurality of data packets associated with a third program in a compressed data buffer; and
maintaining a sufficient number of data packets associated with the third program to enable decoding and displaying of the third program independent of a delay associated with video acquisition of the third program.

11. A method for changing programs between multiplexed programs in a digital data stream, the method comprising:
receiving a digital bitstream comprising a plurality of multiplexed programs;
demultiplexing a plurality of data packets associated with a first program;
storing the plurality of data packets associated with the first program;
decoding the stored data packets associated with the first program;
displaying the decoded data packets associated with the first program;
demultiplexing a plurality of data packets associated with a second program;
storing the plurality of data packets associated with the second program, wherein the stored data packets associated with the second program include a first random access point; and
maintaining in a computer memory data associated with the random access point until data associated with a second random access point is received.

12. The method according to claim 11 further comprising discarding data packets associated with the second program that are received at a point earlier-in-time than the first random access point.

13. The method of claim 11 further comprising demultiplexing a plurality of data packets associated with the first program.

14. The method of claim 11 further comprising storing the plurality of data packets associated with the first program in a compressed data buffer.

15. The method of claim 11 the maintaining further comprising substantially continuously maintaining a random access point associated with the second program in the compressed data buffer.

16. The method of claim 11 further comprising:
demultiplexing a plurality of data packets associated with a third program;
storing the plurality of data packets associated with a third program in a compressed data buffer; and
maintaining a sufficient number of data packets associated with the third program to enable decoding and displaying of the third program independent of a delay associated with video acquisition of the third program.
Last independent claim has to identify the approximate amount of time that the bitstream has between random access points.

17. One or more computer-readable media storing computer-executable instructions which, when executed by a processor on a computer system, perform a method for changing programs between multiplexed programs in a digital broadcast, the instructions comprising:
a first instruction code for decoding stored data packets associated with a first program;
a second instruction code for displaying the decoded data packets associated with the first program;
a third instruction code for demultiplexing a plurality of data packets associated with a second program;
a fourth instruction code for storing the plurality of data packets associated with the second program, wherein the stored data packets associated with the second program include a first random access point; and
a fifth instruction code for maintaining data associated with the first random access point until data associated with a second random access point is received.

18. The computer readable media of claim 17 further comprising a sixth instruction code that erases data associated with the first random access point when data associated with a second random access point is received.

19. A digital processing system comprising:
processing circuitry;
a memory coupled to said processing circuitry; and
apparatus that stores the first, second, third, fourth, and fifth instruction codes as defined in claim 17, said apparatus being coupled to the processing circuitry and the memory.

20. A printed circuit board on which is mounted apparatus as defined in claim 19.

21. The printed circuit board defined in claim 20 further comprising a memory mounted on the printed circuit board and coupled to the apparatus.

22. The printed circuit board defined in claim 20 further comprising processing circuitry mounted on the printed circuit board and coupled to the apparatus.
